(19) United States
(12) Patent Application Publication
(10) Pub. No.: US 2024/0269832 A1
(43) Pub. Date: Aug. 15, 2024

(54) DRIVE MECHANISM

(71) Applicant: MANISA CELAL BAYAR UNIVERSITESI STRATEJI GELISTIRME DAIRE BASKANLIGI, Manisa (TR)

(72) Inventor: Nuri SARIKAYA, Izmir (TR)

(73) Assignee: MANISA CELAL BAYAR UNIVERSITESI STRATEJI GELISTIRME DAIRE BASKANLIGI, Manisa (TR)

(21) Appl. No.: 18/569,608

(22) PCT Filed: May 30, 2022
(86) PCT No.: PCT/TR2022/050497

§ 371 Date: Dec. 13, 2023

(30) Foreign Application Priority Data
Jun. 14, 2021 (TR) 2021/009716

(51) Int. Cl. B25J 9/16; A61H 3/00; B25J 9/00

(52) U.S. Cl. CPC B25J 9/162; A61H 3/00; B25J 9/0006; A61H 2201/123

(57) ABSTRACT

A drive mechanism is configured for providing biomedical movement similar to the musculoskeletal system for use in exoskeletal motion systems. Accordingly, the drive mechanism includes at least one magnetic block provided successively between a starting point and a finishing point; at least one piston moving to enable said magnetic blocks to approach or move away from each other; a control unit for providing movement of the piston; said control unit being configured to provide energy from a power supply to said starting point at a predetermined value; and to allow the pistons to approach electromagnets according to the amount of energy provided.

### TECHNICAL FIELD

The present invention relates to a drive mechanism designed with an innovative architecture that enables movement similar to the musculoskeletal system for use in exoskeletal movement systems that provide biomedical movement.

### PRIOR ART

External skeleton robots are safe, stable and wearable electromechanical elements that can work in harmony with the human body, and have energy efficiency. These robots are used for the rehabilitation of patients or elderly people with walking disabilities and for enhancing power in military applications. Designed exoskeleton robots make people's lives easier and offer a better quality of life in the areas where they are used.

The human musculoskeletal system provides flexible and stable mobility with minimum energy by changing the stiffness and decay in the joints to which it is bound. Today, studies on exoskeletal robots, where actuator designs, the rigidity of which can be changed, are used are continuing rapidly with developing robot technologies. Since exoskeletal robots must work in constant harmony with the user and are used mobile, the actuators used in these robots are required to be efficient in terms of energy consumption. Hard actuators such as electric motors and hydraulic actuators are not suitable for use in exoskeleton robot designs in order to maintain compatibility with the user at the highest levels and to provide biomimetic mobility. Instead, the use of soft actuators with changeable rigidity has great importance in obtaining the desired properties from these robots.

In exoskeletal studies, hydraulic or pneumatic systems are used to provide the desired lifting power. However, since these systems need a pump, they can only be used for carrying loads. This situation restricts the user's movements and reduces the usefulness of the system. When more precise movements are desired, tools such as servo motors are used. However, when these systems are used for military purposes, they cannot provide the desired power. It is also ensured that hydraulics are used for humanoid robots. Many hydraulics are used to make the robot's movements resemble human movements. It is ensured that a separate pump is used for each hydraulic fluid used. This prevents the systems from being reduced sufficiently.

All the problems mentioned above have made it necessary to make an innovation in the relevant technical field as a result.

### BRIEF DESCRIPTION OF THE INVENTION

The present invention relates to a drive mechanism in order to eliminate the above-mentioned disadvantages and to bring new advantages to the related technical field.

It is an object of the invention to provide a drive mechanism for exoskeletons that may vary according to the area of use.

The present invention is a drive mechanism for providing biomedical movement similar to the musculoskeletal system for use in exoskeletal movement systems in order to realize all the purposes that are mentioned above and will emerge from the following detailed description. Accordingly, it comprises at least one magnetic block provided successively between a starting point and a finishing point; at least one piston moving to enable said magnetic blocks to approach or move away from each other; a control unit for providing the movement of the piston; said control unit being configured to provide energy from a power supply to said starting point at a predetermined value; and to allow the pistons to approach electromagnets according to the amount of energy provided. Thus, movement is provided by closing the pistons into the magnetic blocks.

A possible embodiment of the invention is characterized in that each of the magnetic blocks comprises a capsule configured to be hollow inside.

Another possible embodiment of the invention is characterized in that it comprises an electromagnet provided in said capsule.

Another possible embodiment of the invention is characterized in that it comprises at least one capsule conductor line that provides electrical transmission on the inner surface of the capsule.

Another possible embodiment of the invention is characterized in that it comprises at least two piston shafts provided on the right and left of the electromagnet.

Another possible embodiment of the invention is characterized in that it comprises at least two shaft holes provided to the piston.

Another possible embodiment of the invention is characterized in that it comprises at least one magnetic element with high magnetic permeability provided on the piston so as to remain between each electromagnet and the piston.

Another possible embodiment of the invention is characterized in that said magnetic element is provided to the right and left of the piston.

Another possible embodiment of the invention is characterized in that it comprises at least one capsule switching element provided to the capsule.

Another possible embodiment of the invention is characterized in that it comprises at least one piston switching element provided to the magnetic element on the right of the piston.

Another possible embodiment of the invention is characterized in that it comprises at least one piston conductor line that enables the transmission of electricity through the piston.

Another possible embodiment of the invention is characterized in that it comprises at least one conductor provided to the magnetic element on the left of the piston.

Another possible embodiment of the invention is characterized in that it is configured to realize the following steps:
providing electricity from the power supply to the starting point;
actuating the first electromagnet by electricity passed through the first capsule conductor line,
the first electromagnet pulling the first magnetic element toward it, depending on the electricity;
the first capsule switching element and the first piston switching element provided with the first magnetic element contact each other;
transferring electricity through the first capsule switching element to the first piston switching element;
transferring electricity from the first piston switching element to the first piston conductor line;
transferring electricity from the first piston conductor line to the first conductor;
transferring electricity through the first conductor to the second capsule conductor line of the second magnetic block,
the same process steps continue until the last magnetic block depending on the amount of power,
terminating electrical transmission by closing the last magnetic block.

Another possible embodiment of the invention is characterized in that the power supply is configured to provide power from the starting point.

Another possible embodiment of the invention is characterized in that the electrical transmission is provided in parallel.

### BRIEF DESCRIPTION OF THE FIGURES

A representative view of the open view of a drive mechanism is given in FIG. 1.

A representative view of the closed view of a drive mechanism is given in FIG. 2.

A representative view of a piston of a drive mechanism is given in FIG. 3.

FIG. 4 shows a representative view of a lateral and three-dimensional view of a magnetic block of a drive mechanism.

A representative view of the series coupling of the multiple drive mechanisms to each other and the parallel coupling of said series coupled drive mechanisms is given in FIG. 5.

A representative view of a basic operating scenario of a drive mechanism is given in FIG. 6.

### DETAILED DESCRIPTION OF THE INVENTION

The subject of the invention is explained with examples that do not have any limiting effect only for a better understanding of the subject in this detailed description.

The present invention relates to a drive mechanism (10) designed with an innovative architecture that enables movement similar to the musculoskeletal system for use in exoskeletal movement systems that provide biomedical movement.

As seen in FIGS. 1 and 2, said drive mechanism (10) comprises at least one magnetic block (11) sequentially arranged between a first starting point (13) and a second finishing point (14). It is ensured that four magnetic blocks (11) are used in a possible embodiment of the invention.

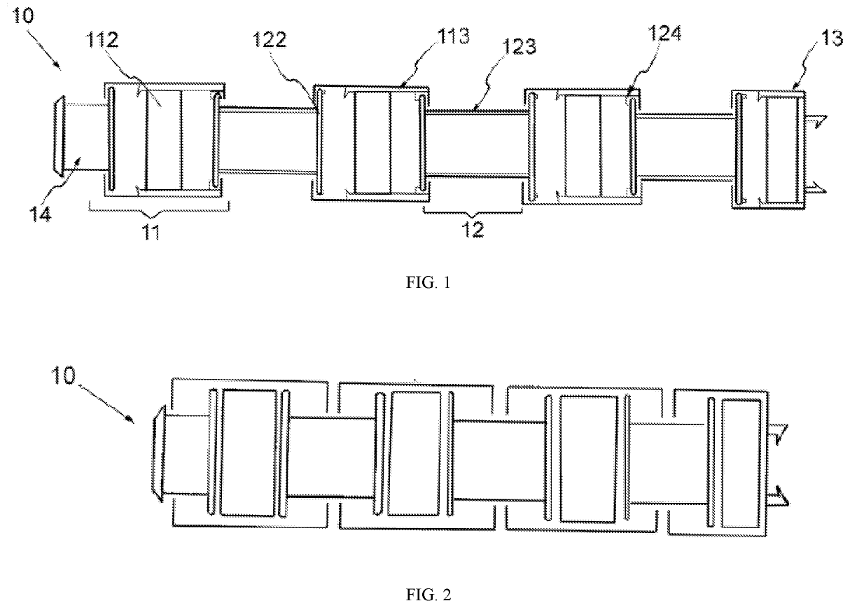

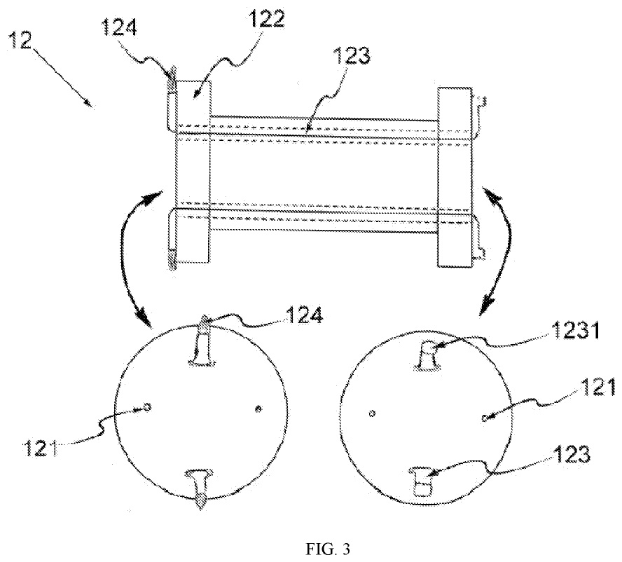

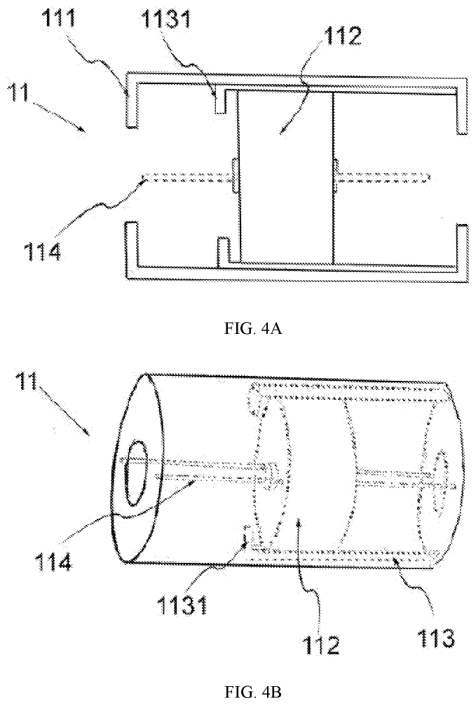

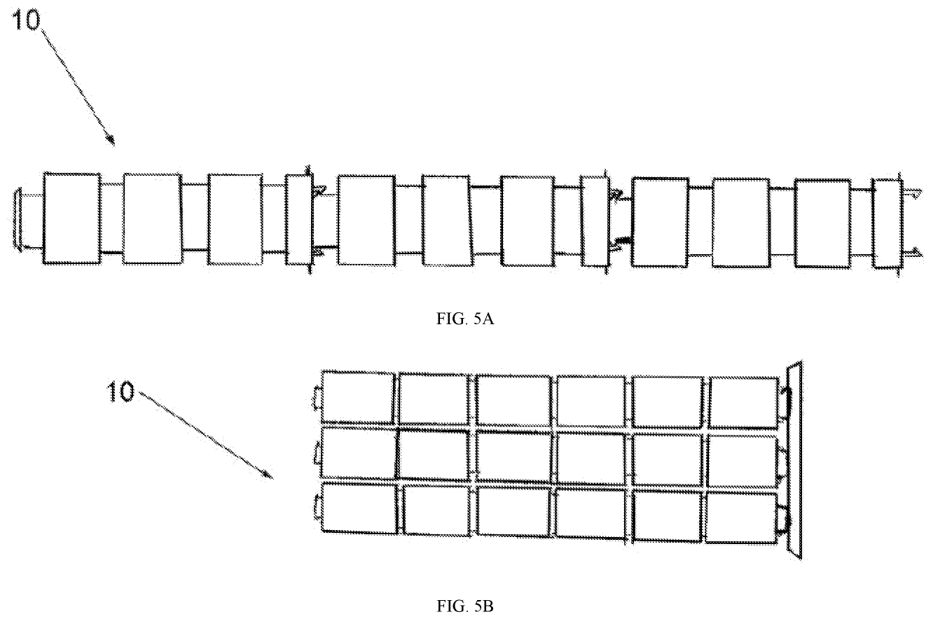

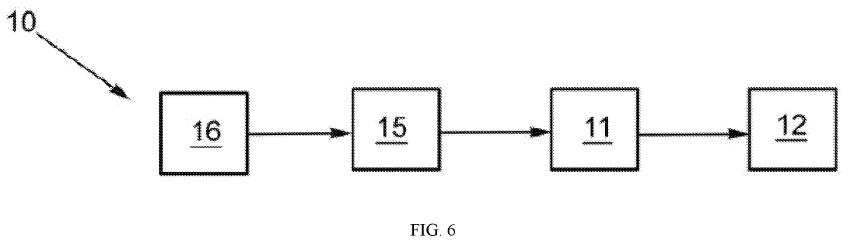

Referring to FIGS. 3 and 4, each of said magnetic blocks (11) comprises a capsule (111) configured to be hollow. There is an electromagnet (112) provided in the capsule (111). Each magnetic block (11) is configured to include an electromagnet (112) provided in a capsule (111). Said electromagnets (112) are configured to carry at least one magnetic block (11) depending on the energy supplied with the entire mechanism. There is a piston (12) provided between two consecutive capsules (111). There is at least one magnetic element (122) with high magnetic permeability provided between each electromagnet (112) provided to the capsule (111) and said piston (12). It is ensured that according to the area of use materials such as ferromagnetic or natural magnets are used as magnetic elements (122) in a possible embodiment of the invention. With the change in the type of material used for the magnetic element (122), the pulling force of the magnetic blocks (11) varies. For this reason, material selection should be made according to the area of use. There is a power supply (16) that connects to the starting point (13) and provides voltage to provide the movement of the drive mechanism (10). There are positive and negative ends for connecting said power supply (16). There is a capsule conductor line (113) provided so as to be at least two for one capsule (111) to enable the electricity received by the power supply (16) from the starting point (13) to actuate the electromagnet (112). There is a capsule switching element (1131) provided to the end of each capsule conductor line (113). There is at least one piston switching element (1231) provided to the magnetic element (122) to be electrically connected with the capsule switching element (1131). The invention is provided with two piston switching elements (1231) on a possible magnetic element (122). The piston switching element (1231) is provided to the magnetic element (122) on the right side among the two magnetic elements (122) provided on the piston (12). The switching elements may be conductor (124) lines such as cables, wires, etc. in a possible embodiment of the invention. By pulling the magnetic element (122) by the electromagnet (112), the capsule switching element (1131) and the piston switching element (1231) are electrically contacted with each other. It is thus ensured that the electricity is transferred from the capsule switching element (1131) to the piston switching element (1231). There are at least two piston shafts (114) provided to the electromagnet (112) to prevent the magnetic element (122) from contacting the capsule conductor line (113) while being pulled by the electromagnet (112). The piston shafts (114) are provided with a total of four, two on the right and two on the left of the electromagnet (112), in a possible embodiment of the invention. There is at least one shaft hole (121) provided to the piston (12) so that it passes through the piston shaft (114).

There is at least one piston conductor line (123) that allows the electricity transferred to the piston switching element (1231) to be carried to the next magnetic block (11) through the piston (12). It is ensured that at least two piston conductor lines (123) are used on a piston (12) in a possible embodiment of the invention. The piston conductor line (123) comprises conductor wires (124) in a possible embodiment of the invention. There are two conductors (124) provided on the magnetic element (122) on the left of the piston (12). The electricity coming from the piston conductor line (123) is transmitted to the conductors (124). The conductors (124) are configured to transmit electricity to the capsule conductor line (113) to which the next magnetic block (11) is connected. Thus, the electromagnet (112) of the second magnetic block (11) is actuated by transmitting the electricity coming from the conductor (124) to the electromagnet (112) provided in the capsule (111) through the capsule conductor line (113). It is ensured that a conductor (124) brush, a conductor (124) wire, a conductor (124) rail etc. are used as said conductor (124) in a possible embodiment of the invention. Said conductor (124) is provided to move back and forth. There is a control unit (15) configured to provide energy to control the movement of the pistons (12). The control unit (15) is configured to actuate the drive mechanism (10) according to the amount of energy received from the power supply (16). In this case, by providing less energy from the power supply (16), a certain number of pistons (12) can be closed, while full closing can be provided if a lot of energy is provided. The closing condition may vary according to the amount of energy.

The drive mechanism (10) is first in the open position as shown in FIG. 1. The drive mechanism (10) can be fully closed, as shown in FIG. 2, by supplying a sufficient amount of energy. The drive mechanism (10) may also be provided with a power increase and sensitivity increase by providing parallel coupling of a plurality of drive mechanisms (10) connected in series to each other as shown in FIG. 5. Thus, it is ensured that the drive mechanism (10) can serve its wide use and purpose by adding or removing it from each other.

The drive mechanism (10) comprises four different models developed depending on the material used for the magnetic element (122). Different models are formed on the same drive mechanism (10) depending on the type of magnetic material and electromagnet (112) that varies according to the area of use. It is ensured that a ferromagnetic material is used as a magnetic element (122) in the first of the mentioned models. If ferromagnetic material is used in the drive mechanism (10), pulling is possible, but pushing is not possible. For this reason, by using ferromagnetic material as a magnetic element (122), two mutually but opposite drive mechanisms (10) are actuated to provide both pulling and pushing features. The ferromagnetic material is preferred in the field of uses where heavy charges can be pulled and in robotic exoskeleton systems due to its high pulling force. It is ensured that ferrimagnetic (permanent magnet) is used as the magnetic element (122) in the second of the mentioned models. Thus, the faces of the two separate permanent magnets in each magnetic block (11) with the electromagnet (112) in the middle are opposite poles. It is ensured that the mentioned model is used in areas where it will not be a problem when the whole mechanism is not used. In this case, there is no need for two separate systems working in the opposite direction. It is ensured that both the push and pull features are used with the same system only by changing the current direction. It is ensured that ferrimagnetic material is used as the magnetic element (122) in the third of the mentioned models. However, the internal structure of the core on the electromagnet (112) is changed and the use of paramagnetic material is ensured. This situation prevents the system from closing with permanent magnets pulling the core when there is no energy. The fourth of the mentioned models is formed by combining the first model and the second model. It is formed by adding the second model drive mechanism (10) behind or between the first model drive mechanism (10). The fourth model ensures that some magnetic blocks (11) are closed thanks to the ferrimagnetic element (122) when not energized. Meanwhile, when a sudden charge is applied, it acts as a suspension and protects the system against possible damage. Thus, it is ensured that the system can be operated with high power.

The control unit is configured to transmit a certain amount of energy to the capsule conductor line (113) of the initial magnetic block (11) via the power supply (16). The electromagnet (112) is actuated with the electricity transmitted to the capsule conductor line (113). A magnetic field is created by actuating the electromagnet (112). Depending on the effect of the magnetic field, the magnetic element (122) is approximated to the electromagnet (112). Electricity is transferred from the capsule conductor line (113) to the capsule switching element (1131). With the approximation of the magnetic element (122) to the electromagnet (112), the piston switching element (1231) provided to the magnetic element (122) and the capsule switching element (1131) are electrically contacted. The first closing is realized when the piston switching element (1231) and the capsule switching element (1131) contact each other. It is ensured that the electricity is transferred from the capsule switching element (1131) to the piston switching element (1231). Electricity is transferred from the piston switching element (1231) to the piston conductor line (123). It is ensured that electricity is transferred from the piston conductor line (123) to the conductor (124). For the second closing, the electricity is transferred through the conductor (124) to the capsule conductor line (113) of the next magnetic block (11). During the closing of each magnetic block (11), energy may be considered to be slightly reduced. In this case, the closing can be provided up to the point where energy is sufficient. The control unit (15) enables the amount of energy supplied to be controlled.

An exemplary operating scenario of the invention is described below;

The power supply (16) provides the energy determined by the control unit (15) from the starting point (13) to the first magnetic block (11). The energy is transferred from the starting point (13) to the first capsule conductor line (113) of the first capsule (111). The first electromagnet (112) is actuated by passing the energy on the first capsule conductor line (113). By actuating the first electromagnet (112), a magnetic field is created in the first magnetic block (11). With the magnetic field formed, the first magnetic element (122) is pulled to the first electromagnet (112). As the first magnetic element (122) approaches the first electromagnet (112), the first piston switching element (1231) provided on said first magnetic element (122) contacts the first capsule switching element (1131) provided on the capsule conductor line (113). When the first capsule switching element (1131) contacts the first piston switching element (1231), energy is transferred from the first capsule conductor line (113) to the first piston conductor line (123). It is ensured that the energy is transferred through the first piston conductor line (123) to the first conductor (124) on the left side of the piston. Said first conductors (124) allow the electricity to be transferred to the next second magnetic block (11). In this case, electricity is transferred through the first conductors (124) to the second capsule conductor line (113) of the second magnetic block (11). The electricity transferred to the second capsule conductor line (113) enables the second electromagnet (112) to be actuated. By actuating the second electromagnet (112), the second magnetic element (122) and the third magnetic element (122) are approximated to the second electromagnet (112). As the third magnetic element (122) approaches the second electromagnet (112), the second switching element provided to the third magnetic element (122) and the second capsule switching element (1131) are brought into contact with each other. It is ensured that the electricity is transferred to the second piston switching element (1231) through the second capsule switching element (1131). The second piston switching element (1231) allows electricity to be transferred to the second piston conductor line (123). The second piston conductor line (123) allows electricity to be transferred to the second conductors (124). The second conductors (124) allow electricity to be transmitted to the next magnetic block (11). Thus, it is ensured that electricity is transferred to the third magnetic block (11) through the second magnetic block (11). The mentioned process continues until the energy is depleted. Energy decreases after each closing. For this reason, the number of capsules (111) to be closed may vary depending on the amount of energy.

Since electricity is connected in parallel, it is ensured that electricity is shared at the end of each pulling. This causes a decrease in the energy of the electricity at each process stage. Thus, the system allows a certain number of magnetic blocks (11) to be pulled depending on the amount of energy provided first. It is necessary to provide great energy in order to close the entire magnetic block (11). A certain number of magnetic blocks (11) are closed with little energy.

As shown in FIG. 5, the drive mechanisms (10) can be connected to each other in series and in parallel to increase the processing power. However, each drive mechanism (10) is energized separately. Furthermore, each drive mechanism (10) may be controlled by different control units (15). In a possible embodiment of the invention, the drive mechanisms (10) perpendicular to each other, as shown in FIG. 5, may be controlled by the same control unit (15).

The control unit (15) allows adjusting the energy to be drawn from the power supply (16) depending on the movement. While it is sufficient to take less energy from the power supply (16) for slight and easy movements, more energy is taken from the power supply (16) for hard and difficult movements. It is ensured that the energy determined by the control unit (15) is transferred from the power supply (16) to the starting point (13). Depending on the energy transferred, the electromagnet (112) in the first magnetic block (11) is actuated. The first electromagnet (112) allows all magnetic blocks (11) up to the finishing point (14) to be pulled towards it with the incoming energy. However, the first magnetic block (11) can only carry the second magnetic block (11) after it. Because it only has an electrical connection to the next magnetic block (11). In this case, the first magnetic block (11) can attract all the magnetic blocks (11), but only the second magnetic block (11) following it can be closed.

In an exemplary operating scenario of the invention, an object is transported by the drive mechanism (10) provided to an exoskeleton system. The control unit (15) enables the amount of energy to be increased according to the weight of the object. Depending on the amount of energy from the starting point (13), the first magnetic block (11) is closed to the second magnetic block. The four magnetic blocks (11) on the drive mechanism (10) are closed starting from the first magnetic block (11) to the fourth magnetic block (11) with the energy received. The object is moved by closing all magnetic blocks (11).

The scope of protection of the invention is specified in the attached claims and cannot be limited to those explained for sampling purposes in this detailed description. It is evident that a person skilled in the art may exhibit similar embodiments in light of the above-mentioned facts without drifting apart from the main theme of the invention.

### REFERENCE NUMBERS GIVEN IN THE FIGURE

10 Drive mechanism
11 Magnetic block
   111 Capsule
   112 Electromagnet
   113 Capsule conductor line
      1131 Capsule switching element
   114 Piston shaft
12 Piston
   121 Shaft hole
   122 Magnetic element
   123 Piston conductor line
      1231 Piston switching element
   124 Conductor
13 Starting point
14 Finishing point
15 Control unit
16 Power supply

What is claimed is:

1. A drive mechanism for providing biomedical movement similar to a musculoskeletal system for use in exoskeletal movement systems, comprising at least one magnetic block provided successively between a starting point and a finishing point;
at least one piston moving to enable the magnetic blocks to approach or move away from each other;
a control unit for providing movement of the piston, wherein
the control unit is configured to provide energy from a power supply to the starting point at a predetermined value and to allow the pistons to approach electromagnets according to an amount of energy provided.

2. The drive mechanism according to claim 1, wherein each of the magnetic blocks comprises a capsule configured to be hollow.

3. The drive mechanism according to claim 2, wherein the drive mechanism comprises an electromagnet provided in the capsule.

4. The drive mechanism according to claim 2, wherein the drive mechanism comprises at least one capsule conductor line, the at least one capsule conductor line provides electrical transmission on an inner surface of the capsule.

5. The drive mechanism according to claim 1, wherein the drive mechanism comprises at least two piston shafts provided on right and left of the electromagnet.

6. The drive mechanism according to claim 1, wherein the drive mechanism comprises at least two shaft holes provided to the piston.

7. The drive mechanism according to claim 1, wherein the drive mechanism comprises at least one magnetic element with high magnetic permeability provided on the piston to remain between each electromagnet and the piston.

8. The drive mechanism according to claim 7, wherein the magnetic element is provided to right and left of the piston.

9. The drive mechanism according to claim 2, wherein the drive mechanism comprises at least one capsule switching element provided to the capsule.

10. The drive mechanism according to claim 7, wherein the drive mechanism comprises at least one piston switching element provided to the magnetic element on right of the piston.

11. The drive mechanism according to claim 1, wherein the drive mechanism comprises at least one piston conductor line, the at least one piston conductor line enables transmission of electricity through the piston.

12. The drive mechanism according to claim 7, wherein the drive mechanism comprises at least one conductor provided to the magnetic element on left of the piston.

13. A method of closing the piston in the drive mechanism according to claim 1, comprising the following steps:
providing electricity from the power supply to the starting point;
actuating a first electromagnet by electricity passed through a first capsule conductor line of a first magnetic block,
the first electromagnet pulling a first magnetic element toward the first electromagnet, depending on the electricity;
a first capsule switching element and a first piston switching element provided with the first magnetic element contact each other;
transferring electricity through the first capsule switching element to the first piston switching element;
transferring electricity from the first piston switching element to a first piston conductor line;
transferring electricity from the first piston conductor line to a first conductor;
transferring electricity through the first conductor to a second capsule conductor line of a second magnetic block,
the same process steps continue until the last magnetic block, depending on the amount of power,
terminating electrical transmission by closing the last magnetic block.

14. The drive mechanism according to claim 1, wherein the power supply is configured to provide power from the starting point.

15. The drive mechanism according to claim 1, wherein electrical transmission is provided in parallel.
